(19) United States
(12) Patent Application Publication
(10) Pub. No.: US 2002/0145217 A1
(43) Pub. Date: Oct. 10, 2002

(54) Method of making preforms

(75) Inventors: Matthew Boyd, Custer, WA (US); David Miller, Marysville, WA (US); John Krogmann, Arlington, WA (US); Corey Nianekeo, Marysville, WA (US); Nathan Dale, Everett, WA (US)

Correspondence Address: FITCH EVEN TABIN AND FLANNERY, 120 SOUTH LA SALLE STREET, SUITE 1600, CHICAGO, IL, 60603-3406, US

(73) Assignee: Brunswick Corporation

(21) Appl. No.: 10/038,771

(22) Filed: Jan. 8, 2002

Related U.S. Application Data
(60) Provisional application No. 60/259,866, filed on Jan. 8, 2001.

(51) Int. Cl. B29C 35/02; B27N 3/00

(52) U.S. Cl. 264/80; 264/109; 264/119; 264/121; 264/122

(57) ABSTRACT

A method of preparing fiber preforms disperses fibers and binder on a forming support surface such that the materials are conditioned and then applied to the surface where the composite material solidifies. Reinforcing material, such as fiber, is mixed with binder, such as thermoplastic or thermoset materials, so that the materials adhere. Then, the adhesive mixture is dispersed in a controlled pre-determined weight ratio on the support surface where the mixture sticks to the support surface, cools and solidifies. The deposited mixture can also be shaped further into a final desired shape before complete solidification. This method eliminates the need for solvents and their associated problems. The process does not require a vacuum or plenum system to hold the reinforcing material in place. The preform can be made in any shape, including sections or asymmetric configurations.

### FIELD OF THE INVENTION

This invention relates to a method of making a preform, particularly for use in composite molded articles. The method especially relates to making a structural preform for use with polymeric materials.

### BACKGROUND OF THE INVENTION

High strength polymeric materials are being increasingly used to replace traditional structural materials, such as metal, in many applications. The polymeric materials have the advantage of lower weight and are often less expensive and more durable than metals. However, polymeric materials tend to be much lower in strength than metal. Unless polymeric materials are reinforced in some manner, they often do not meet the strength requirements for metal replacement.

Thus, polymeric composites have been developed to meet such strength requirements. These composites are characterized by having a continuous polymeric matrix within which is embedded a reinforcement material, which is usually a relatively rigid, high aspect ratio material such as glass fibers.

Such composites are typically molded into a predetermined shape, which is in many cases asymmetric. To place the reinforcement material into the composite, the reinforcement material is usually placed into the mold in a first step, followed by closing the mold and then introducing a fluid molding resin. The molding resin fills the mold, including the interstices between the fibers, and hardens (by cooling or curing) to form the desired composite. Alternatively, the molding resin can be applied to the reinforcing fiber prior to molding. The reinforcing fiber with resin thereon is then placed into a mold where temperature and pressure are applied, curing the resin to prepare the desired composite.

It is desirable to uniformly distribute the reinforcement material throughout the composite. Otherwise, the composite will have weak spots where the reinforcement is lacking. Thus, it is important to prepare the reinforcement material so that the individual fibers are distributed evenly throughout the composite. In addition, the individual fibers should be held in place to resist flowing with the molding resin as it enters the mold, which would disrupt the fiber distribution.

For these reasons, reinforcement has been conventionally formed into a mat outside of the mold. The preform mat is then placed in the mold and either impregnated with resin to make the final composite article, or simply heated and pressed to make a very low density composite article. The mat is generally prepared by forming the reinforcing fibers into a shape matching the inside of the mold and applying a binder to the fibers. In some instances, a thermosetting binder is pre-applied, and then cured after the fibers are shaped into a mat.

In other methods, a thermoplastic binder is applied, so that in a subsequent operation the binder can be heated and softened and the mat subsequently shaped. This binder “glues” the individual fibers to each other so that the resulting mat retains its shape when it is transferred to the mold for further processing. The binder also helps the individual fibers retain their positions when the fluid molding resin is introduced into the mold. In some cases, a molding resin can alternatively be applied to the reinforcing fiber prior to molding. The fiber with binder and resin is placed into a mold where temperature and pressure are then applied, curing the resin to prepare the desired composite.

Binders conventionally used have been primarily of three types, each of which have various drawbacks. The predominantly used binders have been solvent-borne polymers, i.e., liquids, such as epoxy and polyester resins. The solvent-borne binders are usually sprayed onto the mat via an “air-directed” method, and then the mat is heated to volatilize the solvent and, if necessary, cure the binder. This means that the application of binder is at least a two-step process, which is not desirable from an economic standpoint. Also, the use of solvents is encountered, which raises environmental, exposure and recovery issues. Dealing with these issues potentially adds significantly to the expense of the process. The procedure is also energy-intensive, as the entire mat must be heated just to flash off solvent and cure the binder. The curing step also makes the process take longer.

Use of the solvent-borne polymer binders is extremely messy. There are also high maintenance costs associated with keeping the work area and the screen on which the mat is formed clean. In this case, where the binder may be low viscosity fluid, it tends to flow over and coat a large portion of the surface of the fibers. When a composite article is then prepared from a preform made in this way, the binder often interferes with the adhesion between the fibers and the continuous polymer phase, to the detriment of the physical properties of the final composite.

A second form of binder is powdered binders. These can be mixed with the fibers, and then the mass formed into a preform shape, which is heated to cure the binder in situ. Alternatively, these binders can be sprayed to contact the fibers. However, simply substituting a powdered binder in an air-directed method raises problems. For example, powdered binders cannot be applied unless a veil is first applied to the screen to prevent the binder particles from being sucked through. Again, this adds to the overall cost and adds a step to the process. Airborne powders may also present a health and explosion hazard, depending on conditions of use. The use of powdered binders additionally requires a heating step to melt the binder particles after they are applied to the fibers. Heating renders this process energy-intensive.

Binders of a third type are heated thermoplastic materials, which can be melted and sprayed as a binder. Use of these materials makes any subsequent heating step unnecessary, since the binder does not require heat to achieve some undetermined measure of adhesion to the fibers. This method has problems with “lofting,” or inadequate compaction of the preform. Lofting typically occurs because the thermoplastics are conventionally heated to any random temperature above their melting points, leading to a lack of uniformity in their cooling patterns and extensive migration along fiber surfaces. This allows some of the fibers to “bounce back” before they are set into place by the solidifying thermoplastic. This may result in formation of a lower density preform than desired, density gradients throughout the preform, and poor adhesion of the fibers to each other.

In view of the problems discussed herein, one prior art method disclosed in U.S. Pat. No. 6,030,575, which is incorporated herein by reference, applies a heated binder to fibers already supported on a support surface while a vacuum is applied to the other side of the support surface. By this method, the fibers are held in place by the vacuum while the binder is applied at a high pressure by a spray device. This application applies pressure to the fibers thus forming a solid reinforcing structure. Upon application, and with the assistance of the air flow from the vacuum, the binder cools and solidifies into the desired preform shape. However, the application of the vacuum requires additional equipment in the form of a plenum arrangement and also requires additional control functions and labor to properly apply the fibers and vacuum. Therefore, the material and operating costs are increased.

In view of these prior art methods, it would be desirable to provide a simpler method for making preforms in which the problems associated with using solvent-borne, powdered or thermoplastic binders are minimized or overcome. It would also be desirable to provide a lower cost method that is simple to operate and thus more conducive to automation. In a more simple forming process, it may even be possible to eliminate the need to transfer the preform to a molding tool and/or eliminate the need to apply a vacuum to the forming surface.

### SUMMARY OF THE INVENTION

An aspect of this invention provides a method in which a high strength structural preform can be made efficiently and at a lower cost.

Another aspect of this invention provides a method of making a preform that does not require the use of solvents.

A further aspect of this invention provides a method of making a preform that can assume a variety of shapes, including asymmetric parts or portions of parts.

An additional aspect of this invention provides a method that uses less components and thus reduces the capital entry and operational production costs.

This invention can be easily adapted to automated production and/or control.

A method in accordance with this invention comprises the steps of providing reinforcing material, providing binder material, mixing the reinforcing material and the binder material so that the binder material adheres to the reinforcing material, applying a stream of the mixture to a support surface thereby adhering the mixture to the support surface, and solidifying the mixture to form the preform.

In particular, the method relates to making a preform for use in forming a structural part in which a stream of fibrous reinforcing material is provided, particulate binder material is adhered to the reinforcing material by providing a stream of heated binder material to the stream of fibrous reinforcing material to form an adhesive mixture, and the adhesive mixture of the reinforcing material and the binder material is sprayed against a support surface such that the mixture adheres to the support surface and solidifies into the preform.

Preforms made in accordance with the method and its variations described herein are also encompassed by this invention.

It is to be understood that the invention described herein can be varied in a number of ways and is not restricted to the particular embodiments described herein. The invention is intended to generally include any embodiment in which the fiber and binder material is combined prior to application to the surface where it then solidifies in the desired shape.

### BRIEF DESCRIPTION OF THE DRAWINGS

The invention will be described in greater detail in conjunction with the following drawings wherein:

FIG. 1 is a schematic perspective view of an end effector depositing the material onto a surface to make a preform in accordance with an aspect of this invention;

FIG. 2 is a schematic perspective view of a preform being made in accordance with an aspect of this invention;

FIG. 2A is an enlarged partial section of one type of forming surface for use with the method in accordance with the invention;

FIG. 2B is an enlarged partial section of another type of forming surface for use with the method in accordance with the invention;

FIG. 2C is an enlarged partial section of another type of forming surface for use with the method in accordance with the invention;

FIG. 2D is an enlarged partial section of the preform formed by the method in accordance with the invention;

FIG. 3 is a front view of an end effector for use with an embodiment of the method in accordance with the invention;

FIG. 4 is a side perspective view of the end effector of FIG. 3; and

FIG. 5 is a front perspective view of an end effector for use with another embodiment of the method in accordance with the invention.

### DETAILED DESCRIPTION OF PREFERRED EMBODIMENTS

This invention is described below with reference to formation of a preform for use in the marine industry to construct fiberglass reinforced articles, such as a hatch, deck, deck section or a boat hull. However, it is to be understood that this is an exemplary embodiment only and that the method can be applied in various applications in which high strength structural members are used. For example, a preform made in accordance with the disclosed embodiments of the invention could be used in the automotive, aircraft, or building industries or as a component of household goods, such as appliances. Further, although specific examples of materials are provided herein, any suitable material can be used.

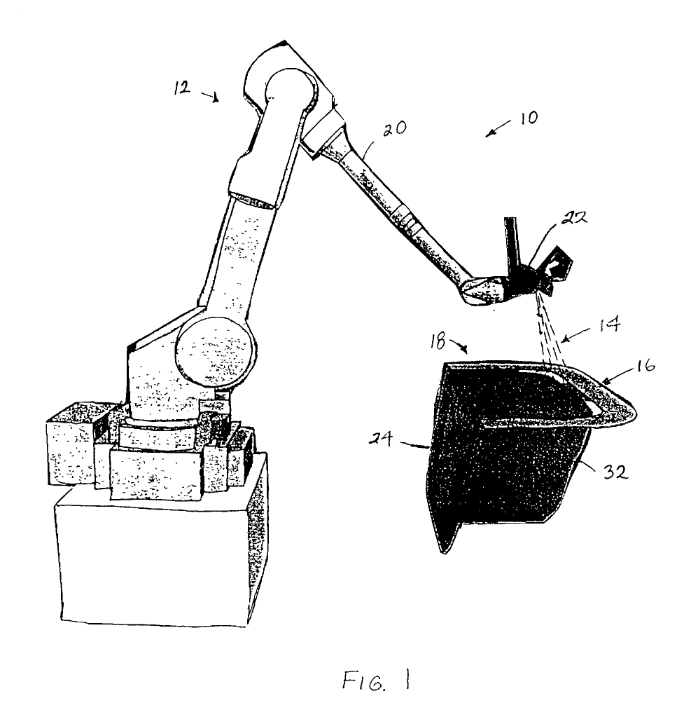

As seen in FIG. 1, a preform making assembly 10 used to practice the method in accordance with the invention includes a materials applicator 12 that applies the preform material mixture 14 to a support surface 16 to create preform 18. The term preform in this application is intended to cover any structure used as a reinforcing insert or structural support within a composite structural part, which is preferably, but not necessarily, a molded part. Such a preform 18 can be used within a mold or as a part of the mold support structure. For example, preform 18 could be placed within a closed mold or on an open mold (a tray or base, for example) to form the composite part. Alternatively, preform 18 could be used as a base structure having materials attached or molded to it, thus acting as a skeleton or tray and eliminating the need for a mold base or molding tool. Preform 18 can be any desired shape. In its simplest form, it resembles a shaped mat.

Materials applicator 12 in FIG. 1, includes a robotically controlled arm 20 with an end effector 22 that delivers the preform materials mixture 14 to support surface 16. Preform materials mixture 14 are applied by end effector 22 by any known application method, including for example, spraying, blowing, streaming, ejecting, laminating, or draping.

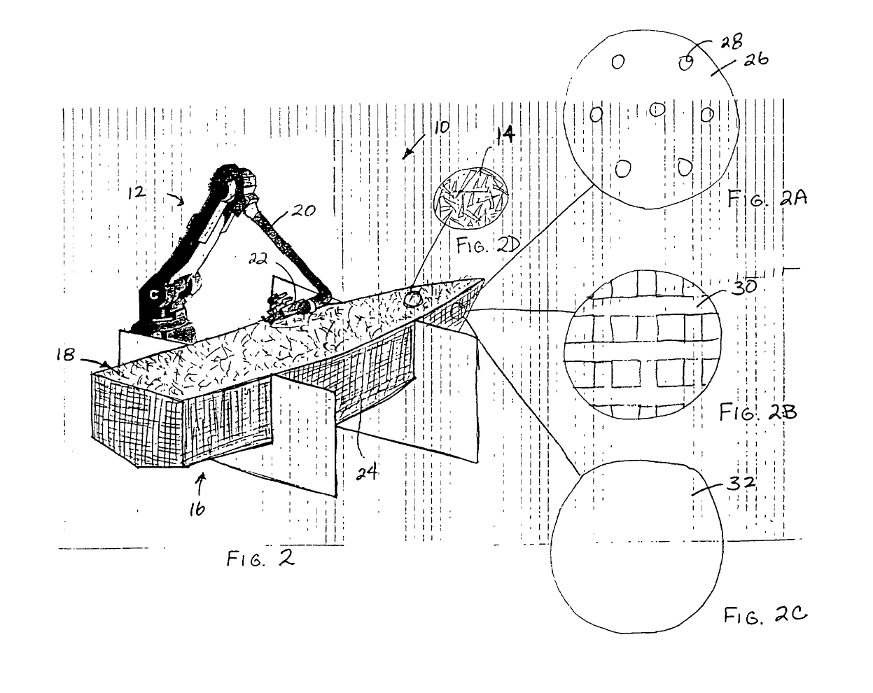

As seen in FIG. 1, support surface 16 can be any surface including an entire part shape or portions of a part. Support surface 16 can include surfaces oriented in any plane. This method is particularly suited for applying material to a vertical surface 24. FIG. 2, for example, shows a preform 18 shaped as an entire boat hull, which will serve as a free standing structural base during molding. In this case, preform materials mixture 14 applied to support surface 16 includes randomly oriented chopped glass fibers retained by a thermoplastic binder, as seen in FIG. 2D.

As will be recognized, support surface 16 can be made of any suitable material, including fiberglass, metal or ceramic, especially materials known for use in molding tools. The surface can also be pretreated if desired. For example, if preform 18 will be used merely by compressing and heating the preform without additional molding steps, it may be desirable to powder coat support surface 16. Also, surface treatments used for molding can be employed, such as a gel coat, mold release agent, peel shell or veil, used alone or in various combinations. Obviously, the intended use of preform 18 can dictate the precise configuration of support surface 16.

FIGS. 2A-2C show variations of support surface 16 usable with the method in accordance with embodiments of the invention. Support surface 16 can be a perforated plate-like member 26 with apertures 28, as seen in FIG. 2A, which allows air to flow through apertures 28 in member 26 during application. Although, as described below, there is no controlled air flow at support surface 16, ambient air trapped between support surface 16 and mixture 14 during application can escape through apertures 28, thus providing more control during application of mixture 14 and a more compact preform 18.

Alternatively, support surface 16 can be a stiff mesh 30 as seen in FIG. 2B. In this embodiment, mixture 14 can adhere to mesh 30 and integrate mesh 30 into the preform structure, thus adding rigidity. Mesh 30 also has the additional advantage of allowing ambient air to flow through its apertures during application of mixture 14. Mesh 30 can be any suitable material, including fiberglass, plastic, metal, wood or any combination thereof. Mesh 30 offers advantages during subsequent molding by providing interstices into which later applied resin can flow and bind.

FIG. 2C shows a third type of support surface 16 suitable for this method. In this case, support surface 16 is a solid plate 32. A solid plate surface 32 is also shown in FIG. 1 in which a preform for a part is being formed. Mixture 14 directly adheres to plate 32 during application. This variation can result in a compact preform structure 18 as mixture 14 is pressed onto plate 32. Also, in this case, solidified mixture 14 can have a smooth outer surface for later treatment.

Support surface 16 also does not need to be shaped into the final desired shape of preform 18. Because mixture 14 is applied while tacky or viscous, by controlling the applied viscosity, mixture 14 can be pressed into a different desired shape than support surface 16 before solidification. This allows a large degree of flexibility in preform shapes as preform 18 is not restricted to the shape of support surface 16.

Any suitable materials can be used to create preform 18. The reinforcing material can be any material suitable as use as reinforcement. Preferably, the reinforcing material is a relatively rigid, high aspect ratio material. In this preferred embodiment, the material is a chopped fibrous material such as fiberglass. The material can be provided as a chop, or it can be chopped during or just prior to the application process. It is preferable that the reinforcement provides a surface with interstices so that subsequently applied molding material can closely bind with the reinforcement.

The binder can be a commercially available particulate binder material, including thermoplastic and thermoset polymers, cellular and non-cellular polymers, glasses, ceramics, metals, or multi component reactive systems. One type of suitable binder, for example, is a thermoplastic epoxy hybrid. Preferably, the binder is a true solid or supercooled liquid at the ambient temperature prevailing during use so that volatile organics such as solvents are not present in significant amounts. By this, environmental problems associated with solvents can be avoided. Further, the binder is preferably a material that does not need post heat treatment for curing, thus reducing time and energy requirements. The particular material can be any known binder, preferably one that can be conditioned, melted without significant decomposition, adhered to reinforcing material upon cooling, and durable at temperature ranges typical in molding. The particular binder can be selected based on the desired characteristics of the preform and its ultimate intended use.

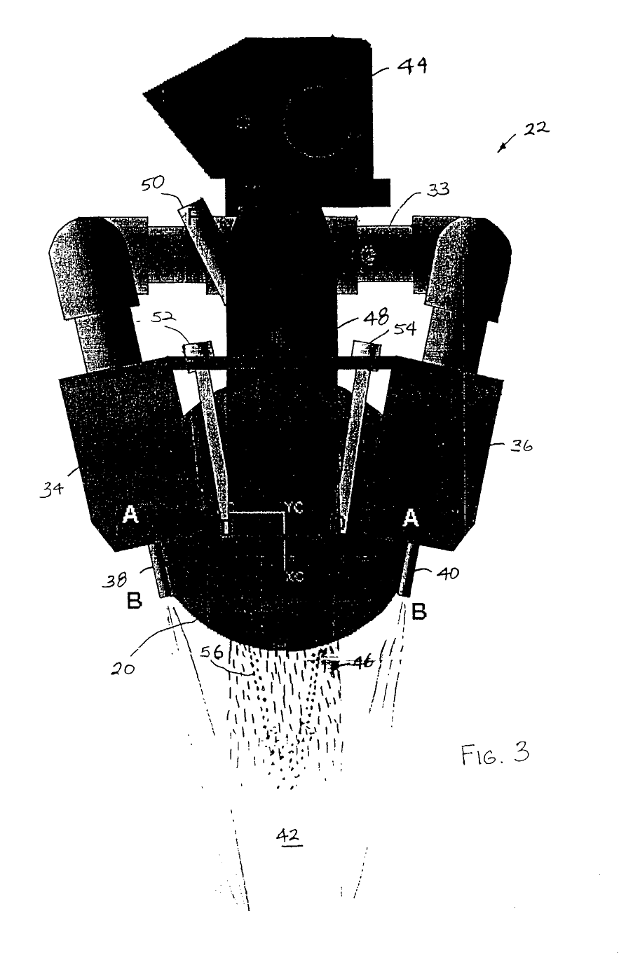

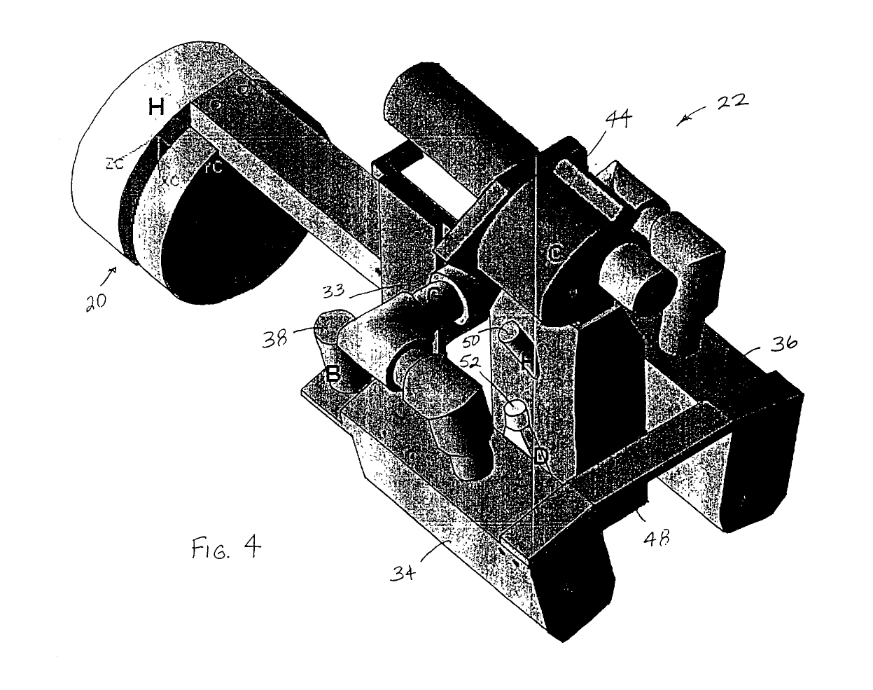

One type of suitable end effector 22 is shown in detail in FIGS. 3 and 4. End effector 22 is any element that can deliver material in accordance with the method and its variations disclosed herein. End effector 22 is preferably carried by robotic arm 20, but obviously could be manually or otherwise supported. In this method, a dual heat element configuration is employed. As seen in FIG. 3, a balanced split supply header 33, preferably natural gas, feeds two burners 34 and 36. The balanced header 33 splits a main header to allow common feed to burners 34 and 36 to maintain uniformity and equity of gas mixture supply and inlet pressure conditions in-process.

Each burner 34 and 36 has a burner ignition element 38 and 40, respectively, which could be capable of program driven ignition or manual remote control. As will be described below, the dual burner configuration creates a heat envelope or zone 42 within the flames thrown by burner ignition elements 38 and 40.

Preferably, burner(s) 34 (36), for example, provides a controlled, variable and even temperature profile with a nominal capacity of about 10,000 BTU per lineal inch of burner. Burner(s) 34 (36)can include a supplied gas mixture control cabinet with sensors that continually monitor and correct flame mixture quality and oxygen content. Thus, flame quality can be controlled within predetermined limits. Automatic shutdown can be provided when the specified parameters are exceeded or if unsafe mixture conditions occur. Of course, any number of burners could be used depending on the desired size and configuration of heat zone 42. The use of natural gas is preferred for cost and efficiency, but any fuel could be used. A low pressure flame can also be employed. For example, the flame velocity can be around 1000 feet per minute.

Reinforcing material is provided by material chopping device 44. Chopping device 44 can vary depending on the type of material being chopped. Chopping device 44 may be fully integrated with the process control system to allow in-process start, stop, and run parameter adjustment based on control program requirements or process sensors and control system signals from process monitoring. Chopping device 44 may also be manually controlled or varied by operator input. It is also possible to use pre-chopped material or other particulate material if desired.

Chopped material 46 is fed through material shape tube 48. Chopped material 46, also called “chop”, can be blown, dropped, ejected or otherwise expelled from tube 48. Tube 48 is designed to provide a discrete controlled area for material processing in preparation for introducing chopped material 46 into the material stream. It can also provide a controlled volume for any material conditioning medium that may be desired. As seen in FIG. 3, chopped material 46 is fed in a stream toward heat zone 42. An air inlet 50 is provided in tube 48 to assist in shaping the stream of chopped material 46 as it is expelled from tube 48.

Binder introduction ports 52 and 54 deposit binder 56, in the form of streams, toward heat zone 42. Ports 52 and 54 are preferably designed to introduce air conveyed binder from a metered dispensing unit into the material stream. Binder 56 can be in the form of particulate or any conventional form that can be mixed in with chopped fibers 46, as noted above. In this arrangement, binder 56 is presented as dual streams that are interspersed into the flow of chopped fibers 46 prior to entering heat zone 42.

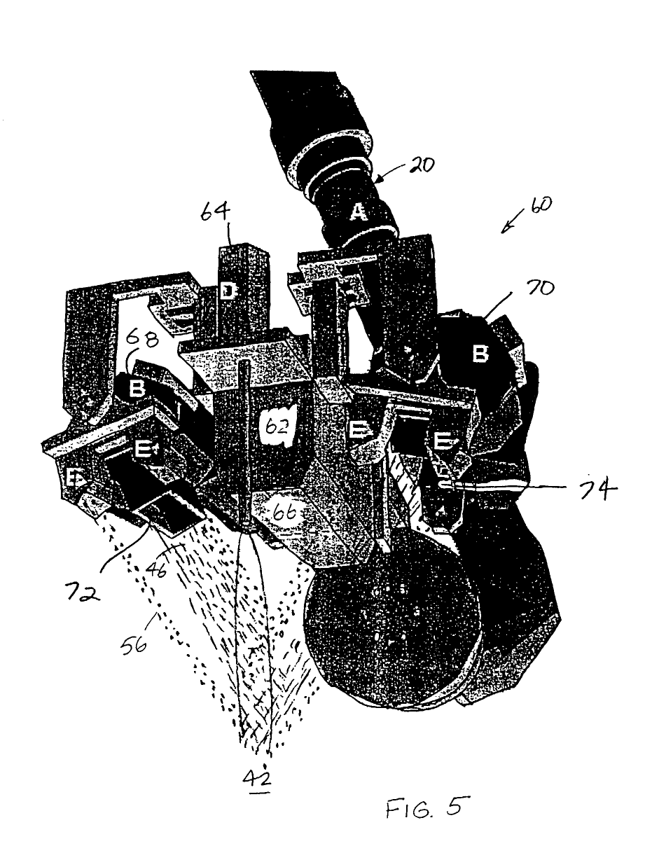

An alternate end effector assembly is shown in FIG. 5, in which an end effector 60 is mounted on robotic arm 20. In this arrangement, a central burner element 62 is provided with a single burner ignition element 64 and a burner face 66. A pair of reinforcement material chopping devices 68 and 70 are positioned on either side of burner element 62 and deliver streams of chopped fiber 46 toward a focal point in heat zone 42 through delivery tubes 72 and 74, respectively. Four binder introduction ports 76, 78, 80, and 82 are provided adjacent to reinforcing material delivery tubes 72, 74 to deliver streams of binder toward the focal point. By this, streams of reinforcing material 46 and binder 56 can be layered together into the heat zone 42 to mix the materials and create an adhesive mixture.

Alternatively, binder 56 can be conditioned by a conditioning device, such as a heater, prior to being introduced into the stream of reinforcing material 46. In this case, no heat zone would be necessary, which would eliminate the gas control cabinet and controls, independent metered binder feed unit, burner supply header, and the ignition and burner elements. Such a binder heater could heat treat the material and then blow air across the surface to eject heated binder particles.

In operation, the particular end effector could vary provided that reinforcing material 46 is delivered to a zone in which heated binder 56 can be mixed therewith. The mixing causes the materials to adhere into an adhesive mixture 14. Adhesive mixture 14 is then deposited onto support surface 16 where it solidifies into preform 18. Use of different end effector arrangements allows different properties to be achieved. Using different numbers of streams or layers of reinforcing material 46 and binder 56 will vary the final preform properties. Similarly, mixing binder 56 after it is heated, before it is heated or while it is being heated will vary the final properties of preform 18.

Of course, any suitable end effector 22 can be used, provided that the appropriate mixing and heat control can be employed. As can be understood from above, preform 18 can be made with different properties by controlling the heat zone, the temperature of the binder, the degree of chop of the reinforcing material, and the distance to support surface 16. For example, the mixing of material can be controlled so that mixture 14 hits support surface 16 while tacky, or slightly sticky, so that it quickly solidifies. Alternatively, mixing can be controlled so that mixture 14 hits support surface 16 while sufficiently viscous to adhere to support surface 16 but remain moldable so that it can be pressed into a desired final shape.

Control of the various elements and parameters can be manual or automated. If automated, a system can be provided using known programming techniques in a controller or processing apparatus, such as a microprocessor. Process control, especially robotic control, can be achieved by robot control signals, process sensor feedback signals, process material regulation, material selection and preset specifications.

The parameters that affect preform fabrication include the level of control of the heat source or flame, the velocity at which the flame, binder and chop are introduced, the ratio between these elements, and the distance of end effector 22 from support surface 16. For example, if a less viscous mixture 14 is desired, binder 56 can be heated to a higher temperature. By this method, application of mixture 14 can be controlled. Mixture 14 also does not need to be applied at a high velocity and pressure. Because mixture 14 adheres to support surface 16, mixture 14 can even be draped over support surface 16 to achieve different qualities in preform 18.

As mixture 14 sticks to support surface 16 due to the conditioning during the mixing operation, no additional methods of holding the reinforcing material 46 in place are needed. This eliminates the need for any vacuum or plenum assembly. Further, since a low pressure flame velocity is used, the problem of blowing reinforcing material off of support surface 16 or to different places on support surface 16 is not present. Additionally, since mixture 14 can be closely controlled, different shapes and thickness of preform 18 can be achieved.

Thus, it can be seen that the method and its variations in accordance with this invention allows complicated shapes to be easily molded directly on a forming surface, thus simplifying the process of making preform 18 and also the ultimate molding processes in which preform 18 is used. Also, one piece preforms, even in large shapes such as boat hulls, can be formed. This reduces labor costs and production time and can result in a stronger composite part.

Preform 18 formed in accordance with any of the above embodiments can be used in a molding process to make a composite structural part. For example, preform 18 may be used in a vacuum molding process in which resin is applied to preform 18 with the assistance of vacuum and then the composite structure is cured. Alternatively, a molding material, such as resin, can be applied to preform 18 and, then, heat and/or pressure can be applied to form the composite part. Also, simply heat and/or pressure can be applied to preform 18 to compress mixture 14 and form a part.

For example, a preform made according to this invention could be used in a molding process having the following basic steps. After the preform is solidified, the preform is placed in a mold and a molding material, such as resin, is applied. The mold can be an open mold or a closed mold in which the molding tool would be applied to the mold prior to introduction of the resin. Then, after the mold is completely filled, the resin is cured. The article can then be removed from the mold and used in that state or further treated or shaped to suit a manufacturing process. Before the introduction of the molding material, the preform could also be shaped prior to complete solidification or heated and shaped to conform to desired molding conditions. Additionally, separate preforms could be used together to form a structural base prior to molding. The preform according to this invention can be used in molding processes such as resin transfer molding (RTM) or structural-resin injection molding (S-RIM). Heat and/or pressure molding steps can be employed in the molding process with such a preform.

Various parts can be made, as noted above, that are useable in the marine industry or other industries that utilize fiberglass reinforced articles. For example, partial hulls, boat decks in whole or part, hatches, covers, engine covers, marine accessories and the like may be manufactured using preforms made in accordance with this process. Similarly, other marine vessels such as personal watercraft may be manufactured with parts made from this process, including for example, engine covers, hulls in whole or part, hatches and the like. Parts made according to this process would also be usable in the automotive industry to manufacture both interior and exterior components or body parts for vehicles. The use of such parts is not limited to vehicles as such parts could be used in any structural article, such as a storage container or construction component.

It is to be understood that the essence of the present invention is not confined to the particular embodiments described herein but extends to other embodiments and modifications that can be encompassed by the appended claims.

What is claimed is:

1. A method of making a preform, comprising:
providing reinforcing material;
providing binder material;
mixing the reinforcing material and the binder material so that the binder material adheres to the reinforcing material;
applying a stream of the mixture to a support surface thereby adhering the mixture to the support surface; and
solidifying the mixture to form the preform.

2. The method of claim 1, wherein the step of applying a stream of the mixture to the support surface occurs in the absence of forced air at the support surface.

3. The method of claim 1, wherein the step of applying a stream of the mixture to the support surface occurs without use of a plenum system.

4. The method of claim 1, wherein the step of applying a stream of the mixture includes spraying the mixture against the support surface.

5. The method of claim 1, wherein the step of providing the reinforcing material includes providing chopped fibers.

6. The method of claim 5, wherein the step of providing the chopped fibers includes providing chopped fiberglass.

7. The method of claim 1, wherein the step of providing the reinforcing material includes emitting a stream of chopped fibers.

8. The method of claim 1, wherein the step of providing binder includes emitting a stream of binder particulate.

9. The method of claim 1, wherein the step of providing binder includes conditioning the binder before mixing the binder with the reinforcing material.

10. The method of claim 9, wherein conditioning the binder includes heating the binder.

11. The method of claim 1, wherein the step of mixing the reinforcing material and the binder includes emitting a stream of reinforcing material and emitting a stream of binder and mixing the streams.

12. The method of claim 11, wherein emitting the streams of reinforcing material and binder includes emitting a plurality of streams wherein the streams are layered together.

13. The method of claim 11, further comprising conditioning the binder prior to emitting the stream of binder.

14. The method of claim 13, wherein conditioning includes heating the binder.

15. The method of claim 11, wherein mixing the reinforcing material and the binder includes applying heat.

16. The method of claim 15, wherein the reinforcing material and the binder are combined before applying the heat.

17. The method of claim 15, wherein the reinforcing material and the binder are combined while the heat is applied.

18. The method of claim 15, wherein applying heat includes creating a flame.

19. The method of claim 15, wherein applying heat includes forming a controlled heat zone and feeding the reinforcing material and binder into the heat zone.

20. The method of claim 1, wherein the step of applying the mixture to a support surface includes applying the mixture to a vertical support surface.

21. The method of claim 1, wherein the step of applying the mixture to a support surface includes applying the mixture to a solid support surface.

22. The method of claim 1, wherein the step of applying the mixture to a support surface includes applying the mixture to a surface having ambient air conditions.

23. The method of claim 1, wherein the step of applying the mixture to a support surface includes applying the mixture to a surface having apertures therein.

24. The method of claim 1, further comprising shaping the mixture after application to the support surface and prior to solidifying.

25. The method of claim 1, wherein the step of solidifying the mixture includes cooling the mixture so that it conforms to the shape of the support surface.

26. The method of claim 1, further comprising applying a moldable material to the preform to form a composite and curing the composite to form a part.

27. The method of claim 26, further comprising applying a vacuum to the composite before the part is cured.

28. The method of claim 1, further comprising applying at least one of heat and pressure to the preform to form a molded part.

29. The method of claim 28, further comprising adding resin to the preform prior to applying at least one of heat and pressure to the preform.

30. A preform formed in accordance with the method of claim 1.

31. A method of making a preform for use in forming a structural part, comprising:
providing a stream of fibrous reinforcing material;
adhering particulate binder material to the reinforcing material by providing a stream of heated binder material to the stream of fibrous reinforcing material to form an adhesive mixture; and
spraying the adhesive mixture of the reinforcing material and the binder material against a support surface such that the mixture adheres to the support surface and solidifies into the preform.

32. The method of claim 31, wherein spraying occurs without forced air adjacent to the support surface.

33. The method of claim 31, wherein spraying occurs in the absence of a plenum system.

34. The method of claim 31, wherein adhering binder material to the reinforcing material includes conditioning the binder material with heat and forcing the conditioned binder material into the stream of reinforcing material.

35. The method of claim 31, wherein adhering binder material to the reinforcing material includes creating a heat zone and feeding the reinforcing material and the binder into the heat zone.

36. The method of claim 31, wherein adhering binder material to the reinforcing material includes layering streams of reinforcing material with streams of binder material in the presence of a flame.

37. The method of claim 31, wherein providing a stream of fibrous material includes blowing chopped fiberglass.

38. The method of claim 31, wherein spraying the adhesive mixture includes spraying the mixture onto a vertical support surface.

39. The method of claim 31, wherein spraying the adhesive mixture includes spraying the mixture onto a solid surface.

40. The method of claim 31, wherein spraying the adhesive mixture includes spraying the mixture onto a perforated surface.

41. The method of claim 31, wherein spraying the adhesive mixture includes spraying the mixture onto the support surface under ambient air conditions.

42. A preform formed in accordance with the method of claim 31.

43. A composite structure molded on the preform formed in accordance with the method of claim 31.
